(19) United States
(12) Patent Application Publication
(10) Pub. No.: US 2022/0001695 A1
(43) Pub. Date: Jan. 6, 2022

(54) NON-RUBBER MASTERBATCHES OF NANOPARTICLES

(71) Applicant: Compagnie Generale des Etablissements Michelin, Clermont-Ferrand (FR)

(72) Inventor: Frederic VAUTARD, Knoxville, TN (US)

(21) Appl. No.: 17/290,144

(22) PCT Filed: Oct. 31, 2019
(86) PCT No.: PCT/US19/59202

§ 371 Date: Apr. 29, 2021

Related U.S. Application Data
(60) Provisional application No. 62/753,535, filed on Oct. 31, 2018.

(51) Int. Cl. B60C 1/00; C08L 9/06; C08K 3/04

(52) U.S. Cl. CPC B60C 1/0016; C08L 9/06; B82Y 40/00; C08K 2201/011; C08K 3/042

(57) ABSTRACT

The invention relates to nano-particle containing rubber formulations having improved physical properties used for manufacturing cured rubber articles and more specifically to a rubber composition containing non-rubber masterbatch containing graphene comprised nanoparticles. Such compositions may be used for articles of manufacture that include, for example, conveyor belts, motor mounts, tubing, hoses, or tires or components thereof.

### BACKGROUND OF THE INVENTION

### Field of the Invention

This invention relates generally to rubber compositions and more specifically, to rubber compositions containing non-rubber masterbatches of nanoparticles.

### Description of the Related Art

As those involved in the rubber industry are aware, rubber compositions are formed by mixing the many components that make up the rubber composition into a mixture that have all the components as well distributed as possible. Failure to have each component well distributed throughout the rubber composition will negatively impact the physical properties of the cured rubber composition.

There is interest in the using graphene based fillers in rubber compositions, especially those that are nanoparticles, i.e., particles having at least one of their dimensions below 100 nm, but there are sometimes problems associated handling the fillers and with obtaining a good distribution of some of these fillers throughout the rubber composition. For example, their bulk density may be very low (e.g., 0.01 to 0.1 g/ml) and their shape may maximize the buoyancy effect that makes their handling very difficult, especially if there is a surrounding air flow as may be necessary for their safe handling. The transfer of such particles from one container to another, or from a container to a mixer, without contaminating the surrounding area may be challenging. Also, the very high surface area of the particles and the potential electrostatic discharge typically associated to carbon-based particles create an explosion risk (mentioned in the SDS of every “graphene” commercial reference). Additionally the build-up of electrically conductive particles can lead to the creation of short circuits in electronic and electrical equipment.

Work continues to find more effective ways to handle these materials without negative effect to the physical properties of the rubber compositions.

### BRIEF DESCRIPTION OF THE DRAWINGS

FIG. 1 shows the Raman spectra obtained from Raman spectroscopy on an exemplary sample of reduced graphene oxide.

### DETAILED DESCRIPTION OF PARTICULAR EMBODIMENTS

Particular embodiments of the present invention include rubber compositions having nanoparticle materials that comprise multiple layers of graphene as stacked platelets distributed throughout the rubber composition. Particular embodiments further include methods for compounding such rubber compositions and articles formed therefrom.

Embodiments of the rubber compositions disclosed herein are formed with nanoparticle materials that comprise multiple layers of graphene as stacked platelets, such materials having first been incorporated into a masterbatch. A masterbatch, as used in the rubber industry, is a mixture of materials that includes a matrix throughout which one or more other components are distributed. When a rubber composition is then ready to be mixed using several different components, the masterbatch is added to the mixer along with other components for incorporation of all it contains throughout the rubber composition.

Typically masterbatches in the rubber industry use a rubber component as the matrix. However, as further disclosed below, rubber compositions comprising a masterbatch of nanoparticle materials comprising multiple layers of graphene distributed throughout a non-rubber matrix provides rubber compositions that upon curing having improved physical properties useful for the manufacture of rubber articles, including tire components. More particularly, the masterbatches include matrix materials that are a plasticizing liquid or a plasticizing resin having a glass transition temperature (Tg) of at least 25° C. or combinations thereof.

In particular embodiments, the rubber compositions disclosed herein are useful for the manufacture of tire components including, for example, those components found in the tire sidewall, those found in the bead area, those found in the tire crown, for tire undertreads and for inner liners. The undertread is a layer of cushioning rubber under the ground-contacting portion of the tread and is typically found in a tread having a cap and base construction. Other useful articles that can be formed from such rubber compositions include, for example, as conveyor belts, motor mounts, tubing, hoses and so forth.

As used herein, “phr” is “parts per hundred parts of rubber by weight” and is a common measurement in the art wherein components of a rubber composition are measured relative to the total weight of rubber in the composition, i.e., parts by weight of the component per 100 parts by weight of the total rubber(s) in the composition.

As used herein, elastomer and rubber are synonymous terms.

As used herein, “based upon” is a term recognizing that embodiments of the present invention are made of vulcanized or cured rubber compositions that were, at the time of their assembly, uncured. The cured rubber composition is therefore “based upon” the uncured rubber composition. In other words, the cross-linked rubber composition is based upon or comprises the constituents of the cross-linkable rubber composition.

As noted above, particular embodiments of the rubber compositions disclosed herein include nanoparticle materials that comprise multiple layers of graphene as stacked platelets that have been incorporated into a non-rubber masterbatch, i.e., the matrix of the masterbatch is not a rubber.

As is known, graphite is made up of layers of graphene, each of the layers of graphene arranged in the honeycomb lattice structure. The graphite can be exfoliated to create nanoplatelets by intercalating the graphite with sulfuric acid followed by expansion generated by a thermal shock, e.g., microwaving. The expanded intercalated graphite can then undergo ball-milling to break the expanded graphite up into smaller particles of graphite that are made up of the stacked graphene layers, typically stacked several layers high, e.g., between 5 and 30 layers.

The process of making reduced graphene oxide differs in some ways from the process of making the particles of graphite made up of the several layers of the stacked graphene. Starting with graphite, the graphite is first oxidized by putting the graphite through harsh oxidizing conditions to form graphite oxide. The most employed current method is the modified Hummers' method that consists of exposing graphite to a blend of sulfuric acid, potassium permanganate and sodium nitrate. The amount of oxidization through such methods can increase the oxygen content from less than 1 atomic percent to more than 30 atomic percent. Then the graphite oxide can be exfoliated to create nanoplatelets by intercalating the graphite oxide with sulfuric acid followed by expansion generated by a thermal shock, e.g., microwaving. The number of stacked platelets is then just a few, e.g., between 1 and 3 layers.

Then to create the reduced graphene oxide, the graphene oxide undergoes a reduction step either through a chemical route (use of a strong reducing agent like hydrazine) or a physical route (heat treatment at a high temperature in an inert atmosphere). After the graphite has undergone these steps of intercalating, oxidation, expansion and reduction, the resulting reduced graphite oxide no longer may be characterized as having its hexagonal lattice structure since much of it has been at least in part destroyed. The reduced graphene oxide is typically in stacks of 1 to 3 layers.

The resulting structure of the reduced graphene oxide includes holes in the lattice with scattered islands of “hexagonal lattice” or “aromatic” structure all surrounded by amorphous carbon. Such structure can be observed using a High-Resolution Transmission Electron Microscope as described, for example, in the article Determination of the Local Chemical Structure of Graphene Oxide and Reduced Graphene Oxide, K. Erickson, et al., Advanced Materials 22 (2010) 4467-4472. The breaking up of the lattice arrangement in the highly repetitive hexagonal form changes the shape of the platelets from being straight with sharp edges to wrinkly, bent shapes for the amorphous form of the reduced graphene oxide and the aromatic phase when including defects (e.g., 5 or 7 carbon rings).

The change in the structure of the reduced graphene oxide over the graphene structure can be demonstrated in the change in their Raman spectrum. Raman spectroscopy can provide the structural fingerprint of a material in known manner and can measure the ratio of non-aromaticity to aromaticity I_{D}/I_{G} of reduced graphene oxide. The “aromatic” portion includes that structure making up the hexagonal lattice typical of graphene while the non-aromaticity is the portion making up the areas damaged by the oxidation/reduction process to which the reduced graphene oxide has been subjected.

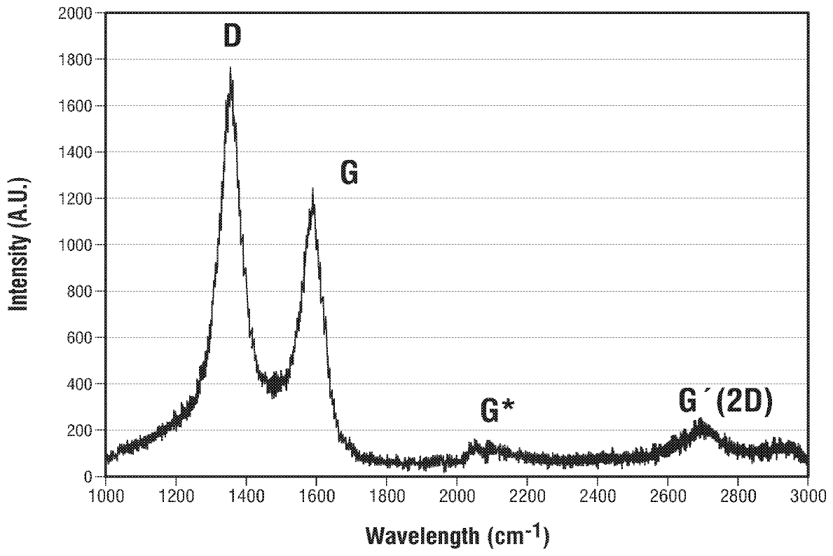

FIG. 1 shows the Raman spectra obtained from Raman spectroscopy on an exemplary sample of reduced graphene oxide. The sample of reduced graphene oxide was N002 PDR available from Angstron Materials. Plotting wavelength against intensity, in known manner the area under the peak around 1600 cm⁻¹ (I_{G}) provides a measurement of the aromatic structure and the area under the peak around 1300 cm⁻¹ (I_{D}) provides a measurement of the defects generated in the lattice of the graphene. It may be noted that the G* peak is due to hydrocarbon chains being present (e.g., perhaps solvent used to sonicate the material before drying) and the 2D is indicative of the number of layers.

The nanoparticle materials (i.e., materials made up of multiple layers of graphene as stacked platelets, e.g., graphite nanoparticles, graphene oxides, reduced graphene oxides) are readily available on the market. For example, Asbury Carbons with offices in New Jersey markets a nano-graphite product 2299 that has a specific surface area of 400 m²/g, carbon content of 94 at %, oxygen content of 4 at %, a ratio of non-aromaticity to aromaticity I_{D}/I_{G} of 0.28, platelets lateral size of 0.1 to 1 micron in stacks of between 18 and 25 platelets high. XG Sciences with offices in Michigan markets an exfoliated graphite product XGnP-M-5 that has a specific surface area of 168 m²/g, carbon content of 97 at %, oxygen content of 3 at %, a ratio of non-aromaticity to aromaticity I_{D}/I_{G} of 0.44, platelets lateral size of 5 microns in stacks of between 15 and 25 platelets high. They have another graphite product XGnP-C-750 that has a specific surface area of 700 m²/g, carbon content of 95 at %, oxygen content of 5 at %, a ratio of non-aromaticity to aromaticity I_{D}/I_{G} of 0.51, platelets lateral size of <1 micron in stacks of between 4 and 10 platelets high.

Vorbeck Materials with offices in Maryland markets a reduced graphene oxide product Vor-X that has a specific surface area of 350 m²/g, carbon content of 92 at %, oxygen content of 5 at %, a ratio of non-aromaticity to aromaticity I_{D}/I_{G} of 1.03, platelets lateral size of 3 micron in stacks of between 1 and 3 platelets high. Angstron Materials with offices in Ohio has a reduced graphene oxide product N002 PDE that has a specific surface area of 830 m²/g, carbon content of 94-95 at %, oxygen content of 5-6 at %, a ratio of non-aromaticity to aromaticity I_{D}/I_{G} of 0.88, platelets lateral size of 9 micron in stacks of between 1 and 3 platelets high.

Angstron Materials as another reduced graphene oxide product that is useful for the rubber composition disclosed herein that has a specific surface area of 860 m²/g, carbon content of 98 at %, oxygen content of <1 at %, a ratio of non-aromaticity to aromaticity I_{D}/I_{G} of 1.42, platelets lateral size of 9 micron in stacks of between 1 and 3 platelets high.

Particular embodiments of the rubber compositions disclosed herein include at least 1 phr or at least 10 phr of the nanoparticle materials that comprise multiple layers of graphene as stacked platelets or alternatively, between 1 phr and 50 phr, between 1 phr and 40 phr, between 1 phr and 30 phr, between 1 phr and 20 phr, between 10 phr and 30 phr, between 10 phr and 40 phr, between 20 phr and 50 phr, between 20 phr and 40 phr or between 20 phr and 30 phr of the nanoparticle materials.

The nanoparticle materials fall within the definition of a nanoparticle, i.e., a particle having at least one dimension no greater than 100 nm. The dimensions of the nanoparticles can be determined in known manner by Transmission Electronic Microscopy (TEM). The TEM can accurately measure to within 0.1 nm a particle ground into a fine power and ultrasonically dispersed in a solvent (such as ethanol). The dimensions of the aggregates themselves, being in the range of tens of microns, such as between 10 microns and 50 microns, can be determined in known manner by Scanning Electron Microscopy (SEM). The dimensions (height and length) are the mean value of all the measured dimensions. Specific surface area may be determined by adsorption of nitrogen and BET (Brunauer-Emmett-Teller) analysis in accordance with ASTM D6556. Oxygen and carbon atomic percentage can be determined by Energy Dispersive X-ray Spectroscopy with a Scanning Electron Microscope.

As mentioned above, the rubber compositions disclosed herein provide that the nanoparticle material be first incorporated into a masterbatch having a non-rubber matrix. The nanoparticles materials that comprise multiple layers of graphene as stacked platelets are distributed in a matrix material that is selected from the group consisting of a plasticizing liquid, a plasticizing resin and combinations thereof. Particular embodiments may limit the matrix to just the plasticizing resin or just the plasticizing liquid.

Plasticizing liquids are well known in the rubber industry. Plasticizing systems, which may include plasticizing liquids and/or plasticizing resins, often provide both an improvement to the processability of a rubber mix and a means for adjusting the rubber composition's physical properties, including for example, its dynamic shear modulus and glass transition temperature.

Suitable plasticizing liquids may include any liquid known for its plasticizing properties with diene elastomers. At room temperature (23° C.), these liquid plasticizers or these oils of varying viscosity are liquid as opposed to the resins that are solid. Examples include those derived from petroleum stocks, those having a vegetable base and combinations thereof. Examples of oils that are petroleum based include aromatic oils, paraffinic oils, naphthenic oils, MES oils, TDAE oils and so forth as known in the industry. Also known are liquid diene polymers, the polyolefin oils, ether plasticizers, ester plasticizers, phosphate plasticizers, sulfonate plasticizers and combinations of liquid plasticizers.

Examples of suitable vegetable oils include sunflower oil, soybean oil, safflower oil, corn oil, linseed oil and cotton seed oil. These oils and other such vegetable oils may be used singularly or in combination. In some embodiments, sunflower oil having a high oleic acid content (at least 70 weight percent or alternatively, at least 80 weight percent) is useful, an example being AGRI-PURE 80, available from Cargill with offices in Minneapolis, Minn. In particular embodiments of the present invention, the selection of suitable plasticizing oils is limited to a vegetable oil having high oleic acid content.

The nanoparticle material/liquid plasticizer masterbatch may be formed by any method that is found to be useful. One method that has been found useful is to mix the liquid and the nanoparticles in a ball mill container using a very coarse agate milling media (balls of 12 mm to 6 mm diameter) and milled for about 20 minutes to avoid as much as possible a size reduction of the particles. The oil masterbatch coats the nanoparticles with the oil resulting a material that may be handed very much like carbon black.

The ratio of the nanoparticle materials by weight to the liquid plasticizer by weight may, in particular embodiments be between 0.1 and 6 or alternatively between 0.5 and 5.5 or between 1 and 3. If higher levels of plasticizing liquid are desired and it is not desired to add all the liquid to the masterbatch, then in particular embodiments additional plasticizer may be added outside of the masterbatch as desired.

A plasticizing hydrocarbon resin is a hydrocarbon compound that is solid at ambient temperature (e.g., 23° C.) as opposed to liquid plasticizing compounds, such as plasticizing oils. Additionally a plasticizing hydrocarbon resin is compatible, i.e., miscible, with the rubber composition with which the resin is mixed at a concentration that allows the resin to act as a true plasticizing agent, e.g., at a concentration that is typically at least 5 phr.

Plasticizing hydrocarbon resins are polymers/oligomers that can be aliphatic, aromatic or combinations of these types, meaning that the polymeric base of the resin may be formed from aliphatic and/or aromatic monomers. These resins can be natural or synthetic materials and can be petroleum based, in which case the resins may be called petroleum plasticizing resins, or based on plant materials. In particular embodiments, although not limiting the invention, these resins may contain essentially only hydrogen and carbon atoms.

The plasticizing hydrocarbon resins useful in particular embodiment of the present invention include those that are homopolymers or copolymers of cyclopentadiene (CPD) or dicyclopentadiene (DCPD), homopolymers or copolymers of terpene, homopolymers or copolymers of C₅ cut and mixtures thereof.

Such copolymer plasticizing hydrocarbon resins as discussed generally above may include, for example, resins made up of copolymers of (D)CPD/vinyl-aromatic, of (D)CPD/terpene, of (D)CPD/C₅ cut, of terpene/vinyl-aromatic, of C₅ cut/vinyl-aromatic and of combinations thereof.

Terpene monomers useful for the terpene homopolymer and copolymer resins include alpha-pinene, beta-pinene and limonene. Particular embodiments include polymers of the limonene monomers that include three isomers: the L-limonene (laevorotatory enantiomer), the D-limonene (dextrorotatory enantiomer), or even the dipentene, a racemic mixture of the dextrorotatory and laevorotatory enantiomers.

Examples of vinyl aromatic monomers include styrene, alpha-methylstyrene, ortho-, meta-, para-methylstyrene, vinyl-toluene, para-tertiobutylstyrene, methoxystyrenes, chloro-styrenes, vinyl-mesitylene, divinylbenzene, vinylnaphthalene, any vinyl-aromatic monomer coming from the C₉ cut (or, more generally, from a C₈ to C₁₀ cut). Particular embodiments that include a vinyl-aromatic copolymer include the vinyl-aromatic in the minority monomer, expressed in molar fraction, in the copolymer.

Particular embodiments of the present invention include as the plasticizing hydrocarbon resin the (D)CPD homopolymer resins, the (D)CPD/styrene copolymer resins, the polylimonene resins, the limonene/styrene copolymer resins, the limonene/D(CPD) copolymer resins, C₅ cut/styrene copolymer resins, C₅ Cut/C₉ cut copolymer resins, and mixtures thereof.

Commercially available plasticizing resins that include terpene resins suitable for use in the present invention include a polyalphapinene resin marketed under the name Resin R2495 by Hercules Inc. of Wilmington, Del. Resin R2495 has a molecular weight of about 932, a softening point of about 135° C. and a glass transition temperature of about 91° C. Another commercially available product that may be used in the present invention includes DERCOLYTE L120 sold by the company DRT of France. DERCOLYTE L120 polyterpene-limonene resin has a number average molecular weight of about 625, a weight average molecular weight of about 1010, an Ip of about 1.6, a softening point of about 119° C. and has a glass transition temperature of about 72° C. Still another commercially available terpene resin that may be used in the present invention includes SYLVARES TR 7125 and/or SYLVARES TR 5147 polylimonene resin sold by the Arizona Chemical Company of Jacksonville, Fla. SYLVARES 7125 polylimonene resin has a molecular weight of about 1090, has a softening point of about 125° C., and has a glass transition temperature of about 73° C. while the SYLVARES TR 5147 has a molecular weight of about 945, a softening point of about 120° C. and has a glass transition temperature of about 71° C.

Other suitable plasticizing hydrocarbon resins that are commercially available include C₅ cut/vinyl-aromatic styrene copolymer, notably C₅ cut/styrene or C₅ cut/C₉ cut from Neville Chemical Company under the names SUPER NEVTAC 78, SUPER NEVTAC 85 and SUPER NEVTAC 99; from Goodyear Chemicals under the name WINGTACK EXTRA; from Kolon under names HIKOREZ T1095 and HIKOREZ T1100; and from Exxon under names ESCOREZ 2101 and ECR 373.

Yet other suitable plasticizing hydrocarbon resins that are limonene/styrene copolymer resins that are commercially available include DERCOLYTE TS 105 from DRT of France; and from Arizona Chemical Company under the name ZT115LT and ZT5100.

It may be noted that the glass transition temperatures of plasticizing resins may be measured by Differential Scanning calorimetry (DSC) in accordance with ASTM D3418 (1999). In particular embodiments, useful resins may be have a glass transition temperature that is at least 25° C. or alternatively, at least 40° C. or at least 60° C. or between 25° C. and 95° C., between 40° C. and 85° C. or between 60° C. and 80° C.

The nanoparticle material/resin plasticizer masterbatch may be formed by any method that is found to be useful. One method that has been found useful is first to dissolve the high glass transition temperature resin in a solvent and then to mix the nanoparticle material into the solution by a combination of mechanical mixing and sonication. The solution may then be heated to evaporate the solvent and concentrate the resin-based masterbatch and then mixed with methanol to precipitate the resin composite. After filtering and drying in an oven, the resulting masterbatch resembled coarse sand.

The ratio of the nanoparticle materials by weight to the high Tg resin plasticizer by weight may, in particular embodiments be between 0.1 and 0.7 or alternatively between 0.1 and 0.5 or between 0.2 and 0.4. If higher levels of plasticizing resin are desired and it is not desired to add all the resin to the masterbatch, then in particular embodiments additional resin plasticizer may be added outside of the masterbatch as desired.

In addition to the non-rubber based masterbatches disclosed above, particular embodiments of the rubber compositions disclosed herein further include a diene rubber. The diene elastomers or rubbers that are useful for such rubber compositions are understood to be those elastomers resulting at least in part, i.e., a homopolymer or a copolymer, from diene monomers, i.e., monomers having two double carbon-carbon bonds, whether conjugated or not.

These diene elastomers may be classified as either “essentially unsaturated” diene elastomers or “essentially saturated” diene elastomers. As used herein, essentially unsaturated diene elastomers are diene elastomers resulting at least in part from conjugated diene monomers, the essentially unsaturated diene elastomers having a content of such members or units of diene origin (conjugated dienes) that is at least 15 mol. %. Within the category of essentially unsaturated diene elastomers are highly unsaturated diene elastomers, which are diene elastomers having a content of units of diene origin (conjugated diene) that is greater than 50 mol. %.

Those diene elastomers that do not fall into the definition of being essentially unsaturated are, therefore, the essentially saturated diene elastomers. Such elastomers include, for example, butyl rubbers and copolymers of dienes and of alpha-olefins of the EPDM type. These diene elastomers have low or very low content of units of diene origin (conjugated dienes), such content being less than 15 mol. %.

Examples of suitable conjugated dienes include, in particular, 1,3-butadiene, 2-methyl-1,3-butadiene, 2,3-di(C₁-C₅ alkyl)-1,3-butadienes such as, 2,3-dimethyl-1,3-butadiene, 2,3-diethyl-1,3-butadiene, 2-methyl-3-ethyl-1,3-butadiene, 2-methyl-3-isopropyl-1,3-butadiene, an aryl-1,3-butadiene, 1,3-pentadiene and 2,4-hexadiene. Examples of vinyl-aromatic compounds include styrene, ortho-, meta- and para-methylstyrene, the commercial mixture “vinyltoluene”, para-tert-butylstyrene, methoxystyrenes, chloro-styrenes, vinylmesitylene, divinylbenzene and vinylnaphthalene.

The copolymers may contain between 99 wt. % and 20 wt. % of diene units and between 1 wt. % and 80 wt. % of vinyl-aromatic units. The elastomers may have any microstructure, which is a function of the polymerization conditions used, in particular of the presence or absence of a modifying and/or randomizing agent and the quantities of modifying and/or randomizing agent used. The elastomers may, for example, be block, random, sequential or micro-sequential elastomers, and may be prepared in dispersion or in solution; they may be coupled and/or starred or alternatively functionalized with a coupling and/or starring or functionalizing agent.

Examples of suitable diene elastomers include polybutadienes, particularly those having a content of 1,2-units of between 4 mol. % and 80 mol. % or those having a cis-1,4 content of more than 80 mol. %. Also included are polyisoprenes and butadiene/styrene copolymers, particularly those having a styrene content of between 1 wt. % and 50 wt. % or of between 20 wt. % and 40 wt. % and in the butadiene faction, a content of 1,2-bonds of between 4 mol. % and 65 mol. %, a content of trans-1,4 bonds of between 20 mol. % and 80 mol. %. Also included are butadiene/isoprene copolymers, particularly those having an isoprene content of between 5 wt. % and 90 wt. % and a glass transition temperature (Tg, measured in accordance with ASTM D3418) of −40° C. to −80° C.

Further included are isoprene/styrene copolymers, particularly those having a styrene content of between 5 wt. % and 50 wt. % and a Tg of between −25° C. and −50° C. In the case of butadiene/styrene/isoprene copolymers, examples of those which are suitable include those having a styrene content of between 5 wt. % and 50 wt. % and more particularly between 10 wt. % and 40 wt. %, an isoprene content of between 15 wt. % and 60 wt. %, and more particularly between 20 wt. % and 50 wt. %, a butadiene content of between 5 wt. % and 50 wt. % and more particularly between 20 wt. % and 40 wt. %, a content of 1,2-units of the butadiene fraction of between 4 wt. % and 85 wt. %, a content of trans-1,4 units of the butadiene fraction of between 6 wt. % and 80 wt. %, a content of 1,2-plus 3,4-units of the isoprene fraction of between 5 wt. % and 70 wt. %, and a content of trans-1,4 units of the isoprene fraction of between 10 wt. % and 50 wt. %, and more generally any butadiene/styrene/isoprene copolymer having a Tg of between −20° C. and −70° C.

The diene elastomers used in particular embodiments of the present invention may further be functionalized, i.e., appended with active moieties. Examples of functionalized elastomers include silanol end-functionalized elastomers that are well known in the industry. Examples of such materials and their methods of making may be found in U.S. Pat. No. 6,013,718, issued Jan. 11, 2000, which is hereby fully incorporated by reference.

The silanol end-functionalized SBR used in particular embodiments of the present invention may be characterized as having a glass transition temperature Tg, for example, of between −50° C. and −10° C. or alternatively between −40° C. and −15° C. or between −30° C. and −20° C. as determined by differential scanning calorimetry (DSC) according to ASTM E1356. The styrene content, for example, may be between 15% and 30% by weight or alternatively between 20% and 30% by weight with the vinyl content of the butadiene part, for example, being between 25% and 70% or alternatively, between 40% and 65% or between 50% and 60%.

In summary, suitable diene elastomers for particular embodiments of the rubber compositions disclosed herein may include highly unsaturated diene elastomers such as polybutadienes (BR), polyisoprenes (IR), natural rubber (NR), butadiene copolymers, isoprene copolymers and mixtures of these elastomers. Such copolymers include butadiene/styrene copolymers (SBR), isoprene/butadiene copolymers (BIR), isoprene/styrene copolymers (SIR) and isoprene/butadiene/styrene copolymers (SBIR). Suitable elastomers may, in particular embodiments, also include any of these elastomers being functionalized elastomers.

Particular embodiments of the present invention may contain only one diene elastomer and/or a mixture of several diene elastomers. While some embodiments are limited only to the use of one or more highly unsaturated diene elastomers, other embodiments may include the use of diene elastomers mixed with any type of synthetic elastomer other than a diene elastomer or even with polymers other than elastomers as, for example, thermoplastic polymers.

In addition to the non-rubber based masterbatch of the nanoparticles and the diene elastomer as discussed above, particular embodiments of the rubber compositions disclosed herein may optionally include a reinforcing filler to achieve additional reinforcing properties beyond those obtained from the nanoparticle materials in the non-rubber masterbatch. Reinforcing fillers are well known in the art and any reinforcing filler may be suitable for use in the rubber compositions disclosed herein including, for example, carbon blacks and/or inorganic reinforcing fillers such as silica, with which a coupling agent is typically associated. Particular embodiments of the rubber compositions may include no additional reinforcing filler and rely only upon the nanoparticles in the non-rubber masterbatch for reinforcement. Other embodiments may limit the additional reinforcing filler to just carbon black or to just silica or to a combination of these two fillers.

Examples of suitable carbon blacks are not particularly limited and may include N234, N299, N326, N330, N339, N343, N347, N375, N550, N660, N683, N772, N787, N990 carbon blacks. Examples of suitable silicas may include, for example, Perkasil KS 430 from Akzo, the silica BV3380 from Degussa, the silicas Zeosil 1165 MP and 1115 MP from Rhodia, the silica Hi-Sil 2000 from PPG and the silicas Zeopol 8741 or 8745 from Huber. If silica is used a filler, then a silica coupling agent is also required as is known in the art, examples of which include 3,3′-bis(triethoxysilylpropyl) disulfide and 3,3′-bis(triethoxy-silylpropyl) tetrasulfide (known as Si69).

In addition to the non-rubber masterbatch having nanoparticle materials, the diene elastomer and the optional reinforcing filler, particular embodiments of the rubber compositions include a curing system such as, for example, a peroxide curing system or a sulfur curing system. Particular embodiments are cured with a sulfur curing system that includes free sulfur and may further include, for example, one or more of accelerators and one or more activators such as stearic acid and zinc oxide. Suitable free sulfur includes, for example, pulverized sulfur, rubber maker's sulfur, commercial sulfur, and insoluble sulfur. The amount of free sulfur included in the rubber composition is not limited and may range, for example, between 0.5 phr and 10 phr or alternatively between 0.5 phr and 5 phr or between 0.5 phr and 3 phr. Particular embodiments may include no free sulfur added in the curing system but instead include sulfur donors.

Accelerators are used to control the time and/or temperature required for vulcanization and to improve the properties of the cured rubber composition. Particular embodiments of the present invention include one or more accelerators. One example of a suitable primary accelerator useful in the present invention is a sulfenamide. Examples of suitable sulfenamide accelerators include n-cyclohexyl-2-benzothiazole sulfenamide (CBS), N-tert-butyl-2-benzothiazole Sulfenamide (TBBS), N-Oxydiethyl-2-benzthiazolsulfenamid (MBS) and N′-dicyclohexyl-2-benzothiazolesulfenamide (DCBS). Combinations of accelerators are often useful to improve the properties of the cured rubber composition and the particular embodiments include the addition of secondary accelerators.

Particular embodiments may include as a secondary accelerant the use of a moderately fast accelerator such as, for example, diphenylguanidine (DPG), triphenyl guanidine (TPG), diorthotolyl guanidine (DOTG), o-tolylbigaunide (OTBG) or hexamethylene tetramine (HMTA). Such accelerators may be added in an amount of up to 4 phr, between 0.5 and 3 phr, between 0.5 and 2.5 phr or between 1 and 2 phr. Particular embodiments may include the use of fast accelerators and/or ultra-fast accelerators such as, for example, the fast accelerators: disulfides and benzothiazoles; and the ultra-accelerators: thiurams, xanthates, dithiocarbamates and dithiophosphates.

Other additives can be added to the rubber compositions disclosed herein as known in the art. Such additives may include, for example, some or all of the following: antidegradants, fatty acids, waxes, and curing activators such as stearic acid and zinc oxide. Examples of antidegradants include 6PPD, 77PD, IPPD and TMQ and may be added to rubber compositions in an amount, for example, of from 0.5 phr and 5 phr. Zinc oxide may be added in an amount, for example, of between 1 phr and 6 phr or alternatively, of between 1.5 phr and 4 phr. Waxes may be added in an amount, for example, of between 1 phr and 5 phr. Plasticizers, including process oils and plasticizing resins, may also be included in particular embodiments of the rubber compositions disclosed herein in amounts, for example, of between 1 phr and 50 phr.

The rubber compositions that are embodiments of the present invention may be produced in suitable mixers, in a manner known to those having ordinary skill in the art, typically using two successive preparation phases, a first phase of thermo-mechanical working at high temperature, followed by a second phase of mechanical working at lower temperature.

The first phase of thermo-mechanical working (sometimes referred to as “non-productive” phase) is intended to mix thoroughly, by kneading, the various ingredients of the composition, with the exception of the vulcanization system. It is carried out in a suitable kneading device, such as an internal mixer or an extruder, until, under the action of the mechanical working and the high shearing imposed on the mixture, a maximum temperature generally between 120° C. and 190° C. is reached.

After cooling of the mixture, a second phase of mechanical working is implemented at a lower temperature. Sometimes referred to as “productive” phase, this finishing phase consists of incorporating by mixing the vulcanization (or cross-linking) system, i.e., the peroxide curing agent (coagents may be added in first phase), in a suitable device, for example an open mill. It is performed for an appropriate time (typically for example between 1 and 30 minutes) and at a sufficiently low temperature lower than the vulcanization temperature of the mixture, so as to protect against premature vulcanization.

The rubber composition can then be formed into useful articles, including tires and tire components, and cured articles. It is surprising that the physical characteristics of the cured rubber compositions are different based on whether they contain the resin-base masterbatch or the liquid-based masterbatch.

Indeed, as can be seen from the samples that follow, the wear properties are not particularly good for any of the formulations but the materials are useful for tire components that are not subject to wear. The resin masterbatch rubber compositions are more useful in energy imposed tire components, such as the undertread of a tire or a component in the bead section of the tire. These compositions demonstrate higher rigidity but with much lower max tan delta, which is the measurement useful for predicting rolling resistance.

The liquid masterbatch materials are useful for the tire components that are strain imposed products, such as the inner liner and sidewall components. The energy dissipation indicate for a strain imposed functioning mode is the loss modulus G″max at 23° C. The liquid masterbatch provide a lower loss modulus that is suitable for strain imposed products.

The invention is further illustrated by the following examples, which are to be regarded only as illustrations and not delimitative of the invention in any way. The properties of the compositions disclosed in the examples were evaluated as described below and these utilized methods are suitable for measurement of the claimed properties of the present invention.

Modulus of elongation (MPa) was measured at 10% (MA10), 100% (MA100) and 300% (MA300) at a temperature of 23° C. based on ASTM Standard D412 on dumb bell test pieces. The measurements were taken in the second elongation; i.e., after an accommodation cycle. These measurements are secant moduli in MPa, based on the original cross section of the test piece.

The elongation property was measured as elongation at break (%) and the corresponding elongation stress (MPa), which is measured at 23° C. in accordance with ASTM Standard D412 on ASTM C test pieces.

Dynamic properties (Tg and G*) for the rubber compositions were measured on a Metravib Model VA400 ViscoAnalyzer Test System in accordance with ASTM D5992-96. The response of a sample of vulcanized material (double shear geometry with each of the two 10 mm diameter cylindrical samples being 2 mm thick) was recorded as it was being subjected to an alternating single sinusoidal shearing stress of a constant 0.7 MPa and at a frequency of 10 Hz over a temperature sweep from −60° C. to 100° C. with the temperature increasing at a rate of 1.5° C./min. The shear modulus G* at 60° C. was captured and the temperature at which the max tan delta occurred was recorded as the glass transition temperature, Tg.

The maximum tan delta dynamic properties, the loss modulus G″ and the shear modulus G*10% for the rubber compositions were measured at 23° C. on a Metravib Model VA400 ViscoAnalyzer Test System in accordance with ASTM D5992-96. The response of a sample of vulcanized material (double shear geometry with each of the two 10 mm diameter cylindrical samples being 2 mm thick) was recorded as it was being subjected to an alternating single sinusoidal shearing stress at a frequency of 10 Hz under a controlled temperature of 23° C. Scanning was effected at an amplitude of deformation of 0.05 to 50% (outward cycle) and then of 50% to 0.05% (return cycle). The maximum value of the tangent of the loss angle tan delta (max tan 6) was determined during the return cycle.

Oxygen permeability (mm cc)/(m² day) was measured using a MOCON OX-TRAN 2/60 permeability tester at 40° C. in accordance with ASTM D3985. Cured sample disks of measured thickness (approximately 0.8-1.0 mm) were mounted on the instrument and sealed with vacuum grease. Nitrogen (with 2% H2) flow was established at 10 cc/min on one side of the disk and oxygen (10% 02, remaining N2) flow was established at 20 cc/min on the other side. Using a Coulox oxygen detector on the nitrogen side, the increase in oxygen concentration was monitored. The time required for oxygen to permeate through the disk and for the oxygen concentration on the nitrogen side to reach a constant value, was recorded along with the barometric pressure and used to determine the oxygen permeability, which is the product of the oxygen permeance and the thickness of the sample disk in accordance with ASTM D3985.

### Example 1

A resin masterbatch was formed by incorporating as the matrix the high Tg resin Oppera 383N, a DCPD-C9 resin available from Exxon-Mobil having a glass transition temperature of 54° C., with Vor-X. A solvent mixing process was utilized in this example. To form the masterbatch, 17.04 grams of the resin was dissolved in 250 ml of toluene under constant stirring for 24 hours. The 5.64 g of the Vor-X nanoparticle material was added to the solution with mechanical stirring and sonicated with a micro tip directly in the solution −3 seconds on, 3 seconds off, for 20 minutes at a maximum allowed power of ˜40 W. The solution was heated to evaporate the solvent and therefore concentrate the resin. Methanol was then added at a ratio of 10:1 to precipitate the resin composite. The resin composite was then filtered with a Buchner funnel and dried in an oven at 80° C. for 12 hours. The material looked like coarse sand. This material was added as the masterbatch in Example 3.

### Example 2

An oil masterbatch was formed by incorporating as the matrix AGRI-PURE 80, available from Cargill, a sunflower oil having an oleic acid content of at least 70 weight percent. 3.93 grams of the oil were added used to form the masterbatch using a ball-milling technique to successfully spread the oil at the surface of the filler. 5.64 g of Vor-X reduced graphene oxide and the sunflower oil were added to the ball-mill steel container along with a very coarse agate milling media (balls of 12 mm to 6 mm diameter) and milled for about 20 minutes to avoid as much as possible a size reduction of the particles. The handling of the oil masterbatch was similar to the handling of carbon black. This material was added as the masterbatch in Example 3.

### Example 3

Rubber compositions were prepared using the components shown in Table 1. The amounts of each component making up the rubber composition shown in Table 1 are provided in parts per hundred parts of rubber by weight (phr). The filler was VOR-X material available from Vorbeck Materials. This material is a reduced graphene oxide having a surface area of 350 m²/g, C and O content of 92 at % and 5 at % respectively, a length of 3 nm and comprising 1-3 layers of stacked graphene.

The additives included wax and 6PPD and the curing package included stearic acid, zinc oxide, sulfur and CBS.

The rubber formulations were prepared by mixing the components given in Table 1, except for the sulfur and accelerator, in a Banbury mixer operating between 25 and 90 RPM until a temperature of between 130° C. and 165° C. was reached. The accelerators and sulfur were added in the second phase on a mill. After curing, the formulations were tested for their physical properties, the results provided in Table 1.

TABLE 1

| | W1 | F1 | F2 |
|---|---|---|---|
| Formulations | | | |
| SBR | 100 | 100 | 100 |
| Filler | 21.5 | 21.5* | 21.5** |
| Sunflower Oil | 15 | 15* | 15 |
| Plasticizing Resin | 65 | 65 | 65** |
| Additives (wax and 6PPD) | 6.4 | 6.4 | 6.4 |
| Curing Package (sulfur, accelerator, | 6.9 | 6.9 | 6.9 |
| actuators) | | | |
| Masterbatch with Liquid Matrix | | * | |
| Masterbatch with Resin Matrix | | | ** |
| Physical Properties | | | |
| MA10 @ 23° C (MPa) | 8.8 | 6.4 | 10.8 |
| MA100 @ 23° C (MPa) | 8.1 | 5.8 | 9.2 |
| MA300 @ 23° C (MPa) | 8.7 | 6.8 | |
| Elongation Stress (MPa) | 6.6 | 5.5 | 6.3 |
| Elongation at Break (%) | 331 | 420 | 200.6 |
| MA300/MA100 | 1.1 | 1.2 | |
| G*10% (MPa) at 23° C. strain sweep | 3.3 | 2.64 | 3.9 |
| G″ max (MPa) at 23° C. strain sweep | 1.7 | 1.17 | 2.2 |
| Max Tan Delta at 23° C. strain sweep | 0.34 | 0.32 | 0.35 |
| G* (MPa) at 60° C. temp sweep | 1.58 | 1.16 | 2.05 |
| at 0.7 MPa | | | |
| Tg (° C.) temp sweep at 0.7 MPa | −0.91 | −10.8 | −15.7 |
| Tan Delta 60° C. temp sweep | 0.22 | 0.21 | 0.25 |
| at 0.7 MPa | | | |
| O2 Permeation, mL · m²/mm · day | 246 ± 16 | 344 ± 13 | 235 ± 28 |

*Filler and Oil mixed as Masterbatch First and then the masterbatch was used
**Filler and Resin mixed as Masterbatch First and then the masterbatch was used

The terms “comprising,” “including,” and “having,” as used in the claims and specification herein, shall be considered as indicating an open group that may include other elements not specified. The term “consisting essentially of,” as used in the claims and specification herein, shall be considered as indicating a partially open group that may include other elements not specified, so long as those other elements do not materially alter the basic and novel characteristics of the claimed invention. The terms “a,” “an,” and the singular forms of words shall be taken to include the plural form of the same words, such that the terms mean that one or more of something is provided. The terms “at least one” and “one or more” are used interchangeably. The term “one” or “single” shall be used to indicate that one and only one of something is intended. Similarly, other specific integer values, such as “two,” are used when a specific number of things is intended. The terms “preferably,” “preferred,” “prefer,” “optionally,” “may,” and similar terms are used to indicate that an item, condition or step being referred to is an optional (not required) feature of the invention. Ranges that are described as being “between a and b” are inclusive of the values for “a” and “b.”

It should be understood from the foregoing description that various modifications and changes may be made to the embodiments of the present invention without departing from its true spirit. The foregoing description is provided for the purpose of illustration only and should not be construed in a limiting sense. Only the language of the following claims should limit the scope of this invention.

What is claimed is:

1. A tire comprising a rubber component, the rubber component comprising a rubber composition based upon a cross-linkable rubber composition, the cross-linkable rubber composition comprising, per 100 parts by weight of rubber (phr);
a diene rubber having a content of diene origins (conjugated diene) that is greater than 50 mol %;
at least 1 phr of nanoparticle materials that comprise multiple layers of graphene as stacked platelets, the nanoparticles materials distributed in a matrix material selected from the group consisting of a plasticizing liquid, a plasticizing resin having a glass transition temperature (Tg) of at least 25° C. and combinations thereof; and
a curing system.

2. The tire of claim 1, wherein the nanoparticles materials are selected from graphite nanoparticles, graphene oxides, reduced graphene oxides and combinations thereof.

3. The tire of claim 2, wherein the stacked platelets are stacked with between 3 platelets and 30 platelets per stack.

4. The tire of claim 1, wherein the diene rubber is selected from the group consisting of natural rubber (NR), polyisoprene rubber (IR), polybutadiene rubber (BR), styrene-polybutadiene copolymer (SBR) and combinations thereof.

5. The tire of claim 1, wherein matrix material is the plasticizing liquid, a ratio of the nanoparticle material by weight to the liquid plasticizer by weight is between 0.1 and 6.

6. The tire of claim 1, wherein matrix material is the plasticizing resin, a ratio of the nanoparticle material by weight to the resin plasticizer by weight is between 0.1 and 0.7.
